(19) United States
(12) Patent Application Publication
(10) Pub. No.: US 2010/0107291 A1
(43) Pub. Date: May 6, 2010

(54) Leg Guards

(76) Inventor: Paul Carter, Fayetteville, NC (US)

Correspondence Address: NOVAK DRUCE + QUIGG LLP, 1300 EYE STREET NW, SUITE 1000 WEST TOWER, WASHINGTON, DC, 20005, US

(21) Appl. No.: 12/526,476

(22) PCT Filed: Feb. 7, 2008
(86) PCT No.: PCT/US08/01600

§ 371 Date: Dec. 23, 2009

Related U.S. Application Data
(60) Provisional application No. 60/888,760, filed on Feb. 7, 2007.

(51) Int. Cl. F41H 1/02; A41D 13/05; B23P 17/04

(52) U.S. Cl. 2/2.5; 2/22; 29/428

(57) ABSTRACT

A ballistic leg guard is provided and includes a pliable outer shell or housing that encompasses a inner ballistic cores which are housed or contained within an inner shell or housing. Secured to exterior portions of the ballistic leg guard are a series of attaching straps and buckles that facilitate the securement of the ballistic leg guard to the wearer lower limb. Secured to and incorporated into an upper portion of the ballistic leg guard is a tourniquet. In one design, the interior ballistic cores comprise high performance fibers such as an aramid fiber, high molecular weight polyethylene, a combination of these, or other high performance fiber types.

### FIELD OF THE INVENTION

The present invention relates to anti-ballistic systems, and more particularly to a versatile human body lower limb anti-ballistic guard that is of a relatively lightweight construction and which provides ballistic protection with a full range of motion and joint articulation for the knee, shin, ankle and foot of an individual, a soldier, or a policeman.

### BACKGROUND

The modern battlefield is more dangerous and violent than ever before. “Smart” weapons, automatic weapons, and improved munitions have dramatically increased the probability of multiple injuries to combatants. Multiple injuries decrease the proportion of surviving wounded. Combat wounds are unique in that there is a high percentage of penetrating wounds and multi-system etiologic injuries with a high degree of wound contamination. The nature of asymmetric warfare has moved a portion of the battlefield in to an urban or indigenous setting. The opponent's unconventional weapon of choice, the Improvised Explosive Device (IED) causes projectile wounds to lower limbs. Lower limb injury caused by explosive discharge, shrapnel, and bullets is the most common battlefield injury. For example, far more than thirty-five (35) percent of United States personnel war wounds in the last ninety (90) years have been projectile injuries to the lower extremities. Modern armor, aggressive application of tourniquets on the injured extremities, and rapid medical care help most of the injured survive.

Ballistic protection systems are widely used throughout the world in military, police, personnel protection, and security applications, The range and types of anti-ballistic protection systems are vast. For example, there is a wide range of heavy0-duty anti-ballistic protection devices that are commonly employed on and around military vehicles. Much attention has been given to the individual soldier or policeman. In that regard, much research and development has been devoted to providing improved body armor, for example, in the form of improved anti-ballistic vests, bulletproof torso protection, etc. However, no feasible option for lower limb protection has been offered.

There continues to be a need for lower limb anti-ballistic protection providing improved range of motion and joint articulation without significantly sacrificing mobility or the ability of the wear to maneuver. Further, there continues to be a need for improve methods of treatment for wounded lower limbs.

### SUMMARY

A ballistic leg guard is provided and includes a pliable outer shell or housing that encompasses a inner ballistic cores which are housed or contained within an inner shell or housing. Secured to exterior portions of the ballistic leg guard are a series of attaching straps and buckles that facilitate the securement of the ballistic leg guard to the wearer lower limb. Secured to and incorporated into an upper portion of the ballistic leg guard is a tourniquet. In one design, the interior ballistic cores comprise high performance fibers such as an aramid fiber, high molecular weight polyethylene, a combination of these, or other high performance fiber types.

### BRIEF DESCRIPTION OF THE DRAWINGS

Other objects, features, and advantages of the present invention will become more apparent from the following detailed description of the invention and certain modifications thereof when taken together with the accompanying drawings in which:

FIG. 1 is an oblique perspective view of a leg guard of the present invention.

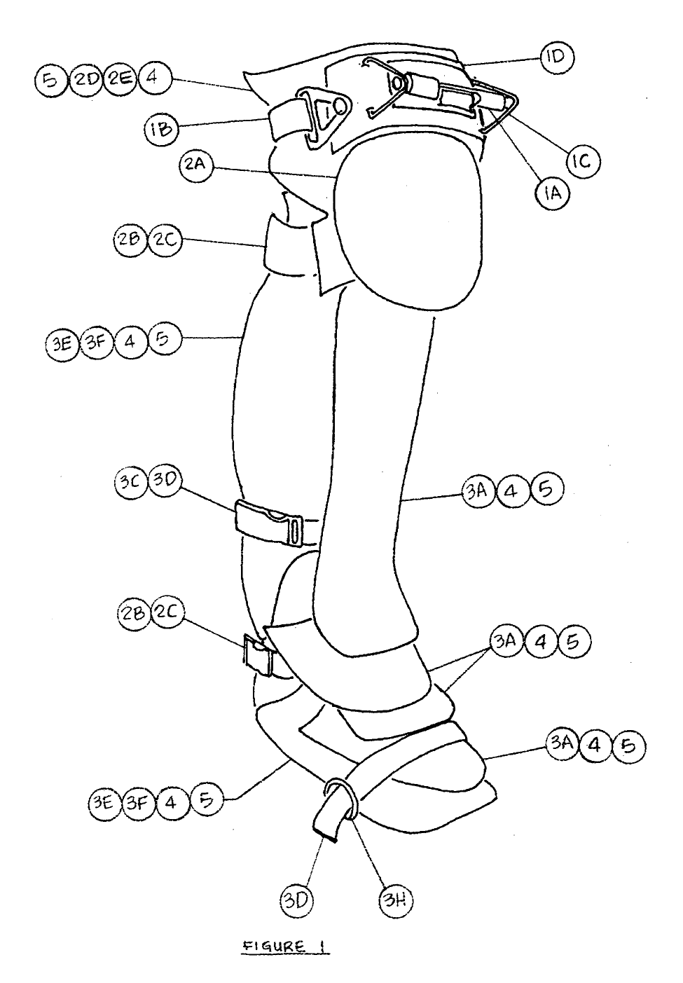

### DETAILED DESCRIPTION

As required, detailed features and embodiments of the invention are disclosed herein. However, it is to be understood that the disclosed features and embodiments are merely exemplary of the technology that may be embodied in various and alternative forms. The FIGURES are not necessarily to scale, and some features may be exaggerated or minimized to show details of particular components. Therefore, specific structural and functional details disclosed herein, and any particular combination of these details, are not to be interpreted as limiting, but merely as a basis for claims and as a representative basis for teaching one skilled in the art to variously employ the technology.

The present invention is configured to primarily provide frontal ballistic protection for the wearer's knee, shin, ankle, and foot. The upper portion of the invention contains contoured frontal plates constructed of a rigid or semi-rigid ballistic material. This protection is supplemented by a layer of pliable ballistic material “backing” which acts as the undercover of the rigid or semi-rigid plate. The rigid or semi-rigid ballistic material is contained within an outer carrier constructed of a pliable, abrasion, moisture, and flame resistant quick drying material capable of accepting various Camouflage design patterns. Furthermore, ballistic material components are encased in a flame retardant material. A contoured protective non-slip support pad provides protection for the knee of the wearer while engaged in tasks that subject this area to discomfort caused by impacts or pressure. The protective support pad protects from protruding objects and debris (e.g. rocks and gravel, glass) and does not restrict range of motion or circulation while remaining securely in place during individual movement tactics. Fasteners provide a secure, continuously contoured ffi during movement and repositioning. Incorporated into the securing straps is a tourniquet comprised of a rigid cylindrical tensioning rod, a tensioning strap circumferentially positioned 2″ to 4″ above the knee. This enables the wearer to rapidly engage the tensioning rod and apply tension to the tourniquet. The end product is a reinforced ballistic covering for lower limbs, and that is designed to defeat small arms and IED attacks, and to increase survivability after sustaining ballistically undefeatable injuries.

The portion of the invention that provides protection to the shin, ankle areas and foot is constructed of contoured segments of rigid or semi-rigid ballistic material providing full frontal skeletal and muscular protection for this portion of the limb. The rigid or semi-rigid ballistic material is contained within an outer carrier constructed of a pliable, abrasion, moisture, and flame resistant quick drying material capable of accepting various Camouflage design patterns. The rigid or semi-rigid pliable carrier is attached to a segment of pliable and flexible high-performance ballistic material that provides side skeletal and muscular ballistic protection. This protective section contains a variety of straps and attachment devices allowing the wearer to secure the device comfortably to the limb above and below the gastronemis (calf muscle). The rigid plates are contoured around to ankle and foot which overlap to allow articulation of the joint to the extent of full range of motion of the foot. The plates snap back to the lowest possible profile position in the range of motion and stay secured to the foot by means of a circumferential strap placed around the instep in a stirrup fashion and attached with the tension desired by the wearer without restriction to circulation blood flow or physical movement of the limb. This device also allows a degree of return assist on each forward step.

The entire device can be donned and doffed over boots and uniforms. The device dimensions are proportionally modified to achieve the proper and comfortable fit for individual body sizes categorized as small, medium, and large. The series of attachment devices are aligned along the lateral leg for rapid disengagement of the item in emergency medical situations, which supports the trauma process.

Web further reference to the drawing, the leg guard is shown herein. Generally the leg guard includes an outer shell, housing, or ballistic material carrier that holds an inner housing or shell indicated by 2E and 3F that in turn encompasses and holds a ballistic material core indicated by 2D and 3E which in one embodiment comprises an aramid fiber panel, ultra-high molecular weight polyethylene fiber panel, or a combination of these and other high performance fibers.

The invention is comprised of these material items: Tourniquet: 1A Tension Rod, 1B Strap, 1C Anchor Clip, 1D Anchor Base; 2A Contoured non-slip rigid, or semi-rigid ballistic material, 2B Strap, 2C Quick Release Fastener, 2D Flexible, pliable ballistic material, 2E Ballistic material cover or “spoil shield”, 2F Contoured rigid or semi-rigid ballistic material plate; 3A Contoured rigid or semi-rigid ballistic material segment, 3C Quick Release Fastener, 3D Strap, 3E Flexible, pliable ballistic material, 3F Ballistic material cover or “spoil shield”, 3H “D” Ring attachment device; 4 Thermal insulation material; 5 Outer shell or ballistic material carrier of a pliable, abrasion, moisture, and flame resistant quick drying material capable of accepting various camouflage design patterns.

As an alternative description of some embodiments, the technology includes a carrier and the ballistics package. The carrier is the envelope that the ballistic package fits into, or otherwise attaches onto for the purpose of holding it in position. The ballistic package is the armor, either flexible or rigid. Ballistic is reference normally to bullets, fragmentation is reference normally to the shrapnel or debris created as primary or secondary missiles during an explosion. The bottom most section which covers the ankle and the top of the foot is modular and may be applied or removed per use need.

The portion of the hybrid ballistic package at the knee: The knee cap is proximate size the standard issue and commercial available impact pads, or a concave shape roughly 6 inches by 8 inches and about 2-3 inches recessed from the rim to the apex of the concave portion, like a knee cap shaped bowl. Underneath and above it are one piece each which is about 2 inches by 6 inches, contoured to wrap around the thigh and shin. This piece above the knee serves as a mounting bracket for the tourniquet. The piece below serves the purpose of continuity of protection during the flexion of the knee. This same piece sets between the knee cap and the shin piece, and constitutes continuity of protection during the articulation of the knee joint of the hybrid.

The shin piece contours the front of the shin and serves the primary purpose of protection from blunt force trauma. It flares at the bottom to such a degree that it will not prevent the foot from being pulled back as high as a wearer can.

The ankle and foot assembly is also comprised of a carrier and a ballistic package. The carrier is comprised of the same material and the same methods as the upper assembly. The ballistic package is comprised of like soft and rigid hybrid configuration as the upper assembly. Generally, there are several leaf shaped contour pieces of rigid material overlaid and anchored to the carrier in such a way as they overlap during ankle extension and retract during ankle retraction. One purpose of this assembly is for impact protection.

The carrier is anchored to the leg by means of attachment mechanisms. Materials for this application may be cloth, nylon, wire or metal based, plastic or other materials. Textile guidelines are in compliance with current ISO manufacturing guidelines. A flexible memory material is used for anchoring the assembly to the leg at the ankle and below the knee. A non-memory, not-stretchy material such as fire resistant nylon webbing is used for the attachment point above the knee that is incorporated into the tourniquet assembly. Since the webbing of this attachment point is the constriction band of the tourniquet, it should not normally, or the tourniquet could not be controlled as expected when tightened. This strap is strong and fire resistant, so that it will survive a blast and not burn or be destroyed, and can still function as a constricting band after a blast on that limb. This strap shall be placed approximately 2 to 4 inches above the knee, in the location a tourniquet would be placed on a patient. It must not be directly behind the knee because it will hamper knee flexion. It would impede the circulation in the leg and would hurt.

The tourniquet strap is between 1 and 2 inches wide, as per accepted tourniquet guidelines. These straps are anchored to the carrier on the medial side, wrap around the back of the leg, and anchor to the lateral side of the leg by means such as hook and loop, clips, mechanic devices, snaps, D-Rings, side release buckles or retainers. The upper strap “tourniquet strap” attach to the plate assembly with a locking mechanism so that the strap will not slip or self loosen. The straps are accessible from the lateral aspect of the wearer so that securing points may be cut away if required for medical treatment. The tension of the straps may be adjusted by means such as a tension buckle, the length of the strap, the strength of the elastic of area, and placement of the hook and loop. This allows for flexibility in limb girth, for the wearing of cold weather clothing, or for a large individuals. The tension bar is a stiff rod about 5 inches long and just large enough to easily grip with one or two hands. It is seated over the securing strap just above the knee cap. Each end is held in place by a triangle-shaped restraining piece. Each restraining device is sewn to the carrier along one flat side, allowing a pointed side to point forward, in which the tension bar is held. The pointed side can fold outward releasing the tension bar, so it can be twisted to tighten the tourniquet. The pointed end of the triangle can then be folded back into position, locking the tension bar in place. The tension rod is covered with a fitted cover/ flap which can be quickly and easily to expose the tourniquet bar. This flap reduces the likelihood that the assembly will snag when not in use.

Rigid impact protection is centered to the front of the device, allowing the soft armor to wrap around the front half of the limb. This allows for a formed fit for different shapes and girth of the extremity. The joints allow only “one way” flexion, which is a stronger joint structure. The foot assembly is held in place relative to the boot by a stirrup that fits under the instep of the boot or the arch of the foot. It is attached to webbing which runs over the top of the foot and is anchored to the carrier for stability. The tension can be controlled as with the straps because the calf Securing straps are 2 elastic, 1 non-elastic and a stirrup under the boot. Access to securing straps from the side, for medical access, may be cut away wholly or by section, as per a tourniquet challenge. The rigid portion of the ballistic package may be disassembled for replacement or maintenance.

1. A flexible lower limb anti-ballistic guard, comprising:
an outer pliable housing having an outer surface and an inner surface, and which forms a generally closed interior area,
the outer housing:
being relatively thin compared to the length and width of the outer housing, and
including a perimeter and including a series of straps disposed around the perimeter of the outer housing;
an inner housing disposed in the interior area of the outer housing and generally surrounded by the outer housing;
a ballistic core contained within the inner housing and comprising
high performance fibers such as high molecular weight polyethylene, aramid fibers, or a combination of these and other high performance fibers;
a plurality of fasteners secured to the outer housing for fastening to other objects and securing the leg guard to a lower limb.

2. The ballistic leg guard of claim 1 wherein:
the outer housing is constructed of material taken from the group including fabric, vinyl, leather, and pliable synthetic materials.

3. The ballistic leg guard of claim 1:
wherein the outer housing includes two sides with one side separated into at least two sections, and
wherein there is provided a plurality of access openings that permits access to the inner housing, and
wherein the access openings at least partially delineates the two sections.

4. The ballistic leg guard of claim 1 wherein:
the outer housing includes two opposed sides, and wherein the straps are secured about outer portions of each side.

5. The ballistic leg guard of claim 1 wherein:
the ballistic core is a high performance fiber such as an aramid fiber, ultra-high molecular weight polyethylene, a combination of these and other high performance fiber types.

6. A ballistic leg guard upper section comprising:
at least one rigid or semi-rigid contoured plate;
at least one shaped layer of pliable ballistic material;
at least one tourniquet comprising rigid material, straps, and rigid holding clips;

7. A ballistic leg guard section comprising:
a plurality of contoured shaped plates of rigid or semi-rigid ballistic material;
at least one shaped layer of pliable ballistic material;
a plurality of straps and fasteners;
at least one elastic material strap.

8. A method of manufacturing a ballistic leg guard, comprising::
forming a pliable outer housing having an outer surface and an inner surface and forming a plurality of generally closed interior areas;
inserting inner housings into the interior area of the outer housing where the inner housings forms enclosures and when inserted into the outer housing, the inner housings are surrounded and generally enclosed by the outer housing;
forming ballistic cores;
forming contoured rigid or semi-rigid plates of high performance fibers such as aramid fibers, ultra-high molecular weight polyethylene, or a combination of these, and other high performance fibers;
inserting ballistic cores into the inner housings such that the ballistic cores are surrounded and enclosed by both the inner housings and the outer housing.

9. The method of claim 8 including:
inserting a high performance fiber such as an aramid fiber, high molecular weight polyethylene material, a combination of these, or other high performance fiber types into the inner housings.
